(19) United States
(12) Patent Application Publication
(10) Pub. No.: US 2025/0144872 A1
(43) Pub. Date: May 8, 2025

(54) WATER DISPERSIBLE BUILD MATERIALS FOR MOLDING APPLICATIONS

(71) Applicant: 3D Systems, Inc., Rock Hill, SC (US)

(72) Inventors: Peter Ke QIN, Rock Hill, SC (US); Jule W. THOMAS, JR., Rock Hill, SC (US); Trevor SNYDER, Rock Hill, SC (US)

(21) Appl. No.: 18/934,830

(22) Filed: Nov. 1, 2024

Related U.S. Application Data
(60) Provisional application No. 63/595,882, filed on Nov. 3, 2023.

(51) Int. Cl. B29C 64/124; B29C 45/26; B29K 105/00; B29L 31/00; B33Y 10/00; B33Y 70/00; B33Y 80/00

(52) U.S. Cl. CPC B29C 64/124; B29C 45/26; B33Y 10/00; B33Y 70/00; B33Y 80/00; B29K 2105/0058; B29K 2105/0094; B29K 2995/0012; B29K 2995/0077; B29L 2031/757

(57) ABSTRACT

In one aspect, compositions or build materials for use with an additive manufacturing system are described herein. In some embodiments, a composition described herein comprises a monomeric curable material, an oligomeric curable material, and a chain transfer agent. In some cases, the monomeric curable material comprises one or more (meth)acrylates and/or one or more (meth)acrylamides. Further, in some embodiments, the one or more (meth)acrylates and/or one or more (meth)acrylamides are hydrophilic or water soluble. Additionally, in some instances, the oligomeric curable material comprises one or more hydrolysable oligomeric species.

### CROSS REFERENCE TO RELATED APPLICATIONS

This application claims priority pursuant to 35 U.S.C. § 119 to U.S. Provisional Patent Application No. 63/595,882, filed Nov. 3, 2023, which is hereby incorporated by reference in its entirety.

### FIELD

The present invention relates to compositions and methods for forming three-dimensional (3D) articles, including using 3D printing and/or molding.

### BACKGROUND

Additive manufacturing systems or 3D printers use build materials, which can also be referred to as inks or polymerizable liquids in some cases, to form various objects, articles, or parts in accordance with computer generated files. In some instances, the build material is solid at ambient temperatures and converts to liquid at elevated jetting temperatures. In other instances, the build material is liquid at ambient temperatures. Build materials can be formed into 3D objects in various manners, such as by jetting or otherwise depositing the build material onto a substrate. Build materials can also be selectively cured, solidified, or otherwise altered during a build. For example, some 3D printers form 3D articles from a reservoir, vat, or container of a fluid build material or a powdered build material. In some cases, a binder material or a laser or other source is used to selectively solidify or consolidate layers of the build material in a stepwise fashion to provide the 3D article.

Additive manufacturing or 3D printing systems can be used to form articles with various end uses. However, the end use of some articles formed by additive manufacturing can be limited by the build material used to form the article. For example, some articles formed by additive manufacturing cannot tolerate high temperatures, cannot be dissolved or dispersed or removed in a desired manner, and/or cannot provide sufficient mechanical strength for certain end uses. Molding applications such as eggshell molding can be particularly difficult to realize. Thus, there exists a need for improved compositions or build materials for 3D printing that have improved properties, particularly related to certain end uses that may require high strength and/or exposure to high temperatures, such as formation of thin molds for injection molding or other molding processes.

### SUMMARY

In one aspect, compositions or build materials for use with a 3D printer are described herein, which, in some embodiments, may offer one or more advantages over prior build materials, particularly radiation-curable build materials for use in additive manufacturing. For reference purposes herein in the context of additive manufacturing, the term “build material” (or its plural) can be used interchangeably with the term “ink” or “polymerizable liquid” (or their plurals). In some embodiments, a composition described herein can be used as a build material to print articles with an improved combination of temperature resistance, strength, and solubility or dispersibility. Moreover, compositions or build materials described herein can be used in a variety of different 3D printers or additive manufacturing systems, such as those based on Stereolithography (SLA), Digital Light Processing (DLP), and Multi-Jet Printing (MJP). Additionally, compositions or build materials described herein, in some cases, may be especially useful for the formation of molds (e.g., eggshell molds) via additive manufacturing. Compositions described herein may also be used in other ways and for other end uses, and the use of a composition described herein is not necessarily limited.

In some embodiments, a composition described herein comprises a monomeric curable material, an oligomeric curable material, and a chain transfer agent. In some cases, the monomeric curable material comprises one or more (meth)acrylates and/or one or more (meth)acrylamides. Further, in some embodiments, the one or more (meth)acrylates and/or one or more (meth)acrylamides are hydrophilic or water soluble. Additionally, in some instances, the oligomeric curable material comprises one or more hydrolysable oligomeric species. Moreover, in some cases, the oligomeric species has two or more polymerizable moieties, such as two or more (meth)acrylate moieties. Further, in some implementations, the chain transfer agent of a composition described herein comprises one or more thiols.

In addition, in some embodiments, a composition described herein further comprises one or more photoinitiators. A composition described herein may also further comprises one or more stabilizers. It is to be understood that such a stabilizer, when present, is different than the chain transfer agent of the composition.

Moreover, in some cases, a composition described herein further comprises a non-reactive polymer or oligomer. Such a non-reactive polymer or oligomer may comprise, for example, a sorbitan ester, an ethoxylated sorbitan ester, a poly (ethylene glycol), and/or a poloxamer.

Other components may also be present in some embodiments of compositions described herein. It is to be understood, of course, that the total amount, or sum of the amounts, of the monomeric curable material, the oligomeric curable material, the chain transfer agent, the photoinitiator (if present), the stabilizer (if present), the non-reactive polymer or oligomer (if present), and additional component(s) (if present) is equal to 100 weight percent (wt. %). In some embodiments, the monomeric curable material is present in the composition in an amount of 5-80 wt. %, the oligomeric curable material is present in the composition in an amount of 1-40 wt. %, the chain transfer agent is present in the composition in an amount of 0.1-10 wt. %, and the non-reactive polymer or oligomer is present in an amount of 1-50 wt. %, based on the total weight of the composition.

Moreover, as described further hereinbelow, a composition disclosed herein may, in some embodiments, have one or more properties or features that are particularly useful for certain end use applications, such as use in molding applications. For example, in some cases, a composition described herein, when cured, exhibits a tensile strength of greater than 40 MPa when determined according to ASTM D638. Additionally, in some instances, a composition described herein, when cured, exhibits a glass transition temperature (Te) of at least 105° C., at least 110° C., or at least 115° C., when measured using dynamic mechanical analysis (DMA) as the maximum of tan delta, and/or has other thermal properties described herein. A composition described herein, in an uncured state, may also have a dynamic viscosity of 5 cP to 30 cP at a temperature of 80° C., when determined according to ASTM D2983.

In another aspect, methods of forming a 3D article by additive manufacturing are described herein. In some embodiments, such a method comprises providing a composition or build material described herein, and selectively curing one or more portions of the composition. Any composition described herein may be used. For example, in some cases, the composition comprises 5-80 wt. % monomeric curable material, 1-40 wt. % oligomeric curable material, and 0.1-10 wt. % chain transfer agent, based on the total weight of the composition.

Moreover, in some cases, providing the composition comprises selectively depositing layers of the composition in a fluid state onto a substrate to form the 3D article. This deposition step may be repeated any desired number of times needed to complete the article. Additionally, in some such embodiments, a method described herein further comprises supporting at least one of the layers of the composition with a support material, such as a hydrophobic or waxy support material. Moreover, in some cases, such a method further comprise removing the support material from the build material or completed article, such as after completion of printing of the article. In some such instances, removing the support material comprises melting the support material off of or away from the build material.

Alternatively, in other embodiments described herein, providing a composition or build material comprises retaining the composition in a fluid state in a container, and selectively curing a portion of the composition comprises selectively applying the curing radiation to the composition in the container to solidify or consolidate at least a portion of a first fluid layer of the composition, thereby forming a first solidified or consolidated layer that defines a first cross-section of the article. Such a method may also further comprise raising or lowering the first solidified layer to provide a second fluid layer of the composition at a surface of the fluid composition in the container, and selectively applying the curing radiation to the composition in the container to solidify at least a portion of the second fluid layer of the composition, thereby forming a second solidified layer that defines a second cross-section of the article, the first cross-section and the second cross-section being bonded to one another in a z-direction. As described further hereinbelow, the foregoing steps may be repeated any desired number of times needed to complete the 3D article.

Additionally, in some embodiments of a method described herein, the composition is selectively cured according to a digital file or image of the article, such as according to preselected computer aided design (CAD) parameters.

Further, as described herein, in some embodiments, the article formed by a method of the present disclosure is a mold, such as an eggshell mold. However, other articles can also be formed by a method described herein.

Thus, in still another aspect, printed 3D articles are described herein. Such a printed 3D article can be formed from any build material and using any method described herein. Such printed 3D articles, in some cases, have superior properties compared to some other 3D articles.

In yet another aspect, methods of forming a 3D article by molding are described herein. In some embodiments, such a method comprises providing a mold defining an interior volume and injecting a fluid material into the interior volume of the mold. In some cases, the method further comprises solidifying the fluid material within the interior volume of the mold to form the article and subsequently removing the mold from the formed article. It is to be understood that the mold can comprise or be formed from a composition or build material described herein. Moreover, as described herein, in some cases, providing the mold comprises forming the mold using additive manufacturing, including using a 3D printing method described herein.

Further, the use of a composition described herein, in some instances, can permit injection of fluid materials at relatively high temperature. For example, in some embodiments, the fluid material is injected at a temperature of at least 150° C., at least 200° C., at least 220° C., at least 250° C., at least 270° C., or at least 300° C. In addition, use of a composition described herein may also permit facile removal of the mold following solidification of the fluid material within the mold. For instance, in some embodiments of a method described herein, removing the mold from the article comprises dissolving or dispersing the mold in water or in an aqueous solution.

These and other embodiments are described in greater detail in the detailed description which follows.

### DETAILED DESCRIPTION

Embodiments described herein can be understood more readily by reference to the following detailed description and examples. Elements, apparatus, and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, 1 to 4, 3 to 7, 4.7 to 10.0, 3.6 to 7.9, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity (that is, the amount is a non-zero amount). For example, a material present in an amount “up to” a specified amount can be present from a detectable (or non-zero) amount and up to and including the specified amount.

It is also to be understood that the article “a” or “an” refers to “at least one,” unless the context of a particular use requires otherwise.

The terms “three-dimensional printing system,” “three-dimensional printer,” “printing,” and the like generally describe various solid freeform fabrication techniques for making three-dimensional articles or objects by stereolithography, selective deposition, jetting, fused deposition modeling, multi-jet modeling, and other additive manufacturing techniques now known in the art or that may be known in the future that use a build material to fabricate three-dimensional objects.

### I. Compositions for Additive Manufacturing

In one aspect, compositions or build materials for use with a 3D printer or additive manufacturing system are described herein. In some embodiments, a composition described herein comprises a monomeric curable material, an oligomeric curable material, and a chain transfer agent. In some cases, the monomeric curable material comprises one or more (meth)acrylates and/or one or more (meth)acrylamides. Additionally, in some instances, the oligomeric curable material comprises one or more hydrolysable oligomeric species. Moreover, in some embodiments, a composition described herein further comprises one or more photoinitiators. A composition described herein may also comprise one or more stabilizers. Further, in some implementations, a composition described herein also comprises a non-reactive polymer or oligomer. Other components may also be present in some embodiments of compositions described herein.

Turning now in more detail to specific components of compositions described herein, a composition described herein comprises a monomeric curable material and an oligomeric curable material. A curable material, for reference purposes herein, comprises a chemical species that includes one or more curable or polymerizable moieties. A “polymerizable moiety,” for reference purposes herein, comprises a moiety that can be polymerized or cured to provide a printed 3D article or object. Such polymerizing or curing can be carried out in any manner not inconsistent with the technical objectives of the present disclosure. In some embodiments, for example, polymerizing or curing comprises irradiating a polymerizable or curable material with electromagnetic radiation having sufficient energy to initiate a polymerization or cross-linking reaction, or exposing the polymerizable or curable material to a reactive species that can initiate a polymerization reaction (e.g., a photoinitiator or other species that has already been “activated” to provide a reactive moiety such as a free-radical moiety). One non-limiting example of a polymerizable moiety of a curable material described herein is an ethyleneically unsaturated moiety, such as a (meth)acrylate moiety, vinyl moiety, or allyl moiety. Moreover, a polymerization reaction, in some cases, comprises a free radical polymerization reaction, such as that between points of unsaturation, including points of ethyleneic unsaturation. Other polymerization reactions may also be used. As understood by one of ordinary skill in the art, a polymerization reaction used to polymerize or cure a curable material described herein can comprise a reaction of a plurality of “monomers” or chemical species having one or more functional groups or moieties that can react with one another to form one or more covalent bonds.

Additionally, an oligomeric curable material and/or a monomeric curable material described herein can comprise a monofunctional, difunctional, trifunctional, tetrafunctional, pentafunctional, or higher functional curable species. A “monofunctional” curable species, for reference purposes herein, comprises a chemical species that includes one curable or polymerizable moiety. Similarly, a “difunctional” curable species comprises a chemical species that includes two curable or polymerizable moieties; a “trifunctional” curable species comprises a chemical species that includes three curable or polymerizable moieties; a “tetrafunctional” curable species comprises a chemical species that includes four curable or polymerizable moieties; and a “pentafunctional” curable species comprises a chemical species that includes five curable or polymerizable moieties. Thus, in some embodiments, a monofunctional curable material of a composition described herein comprises a mono(meth)acrylate, a difunctional curable material of a composition described herein comprises a di(meth)acrylate, a trifunctional curable material of a composition described herein comprises a tri(meth)acrylate, a tetrafunctional curable material of a composition described herein comprises a tetra(meth)acrylate, and a pentafunctional curable material of a composition described herein comprises a penta(meth)acrylate. Other monofunctional, difunctional, trifunctional, tetrafunctional, and pentafunctional curable materials may also be used.

Moreover, a monofunctional, difunctional, trifunctional, tetrafunctional, and pentafunctional curable material, in some cases, can comprise a relatively low molecular weight species, i.e., a monomeric curable species (such as a species having a molecular weight below 300, below 200, or below 100), or a relatively high molecular weight species, i.e., an oligomeric curable species (such as a species having a molecular weight (e.g., a weight average molecular weight in the case of a species having a molecular weight distribution) above 300, above 400, above 500, or above 600, and optionally below 10,000).

Additionally, in some embodiments, a “monomeric” curable material or species has a viscosity of 500 centipoise (cP) or less at 25° C., when measured according to ASTM D2983, while an “oligomeric” curable material or species has a viscosity of 1000 cP or more at 25° C., when measured according to ASTM D2983.

As stated above, compositions described herein can comprise a monomeric curable material. The monomeric curable material can comprise any monomeric curable species not inconsistent with the objectives of the present disclosure. In some cases, for instance, the monomeric curable material comprises one or more (meth)acrylates and/or one or more (meth)acrylamides. It is to be understood that the term “(meth)acrylate” includes acrylate or methacrylate or a mixture or combination thereof. Similarly, it is to be understood that the term “(meth)acrylamide” includes acrylamide or methacrylamide or a mixture or combination thereof. It is further to be observed that a “(meth)acrylate”, for reference purposes herein, can comprise a chemical species comprising at least one acrylate or methacrylate moiety or functional group. Likewise, a “(meth)acrylamide”, for reference purposes herein, can comprise a chemical species comprising at least one acrylamide or methacrylamide moiety or functional group. Moreover, in some embodiments described herein, the one or more (meth)acrylates and/or one or more (meth)acrylamides are hydrophilic or water soluble. A “water soluble” species or material, for reference purposes herein, has a solubility in water (or in an acidic or basic aqueous solution described further herein) of at least 1 gram per 1 liter of water (or of aqueous solution) at 25° C. In some cases, a water soluble species or material has a solubility of at least 5 g/L, at least 10 g/L, or at least 100 g/L at 25° C.

In some embodiments described herein, the monomeric curable material component comprises hydrophilic or water soluble mono-, di-, and/or tri(meth)acrylate species. The monomeric curable material, in some instances, can comprise one or more of hydroxylalkyl(meth)acrylates (e.g., hydroxypropylacrylate); hydroxyalkyl(meth)acrylamides (e.g., N-hydroxyethylacrylamide); N,N-dialkyl (meth)acrylamides (e.g., N,N-dimethyl(meth)acrylamide or N,N-diethyl (meth)acrylamide); stabilized (meth)acrylamides (e.g., N-butyl(meth)acrylamide, N-isopropyl (meth)acrylamide, or diacetone(meth)acrylamide); ethoxylated trimethylol propane triacrylate (“TAC” or trimethylolpropane ethoxylate triacrylate); acryloyl morpholine; and various combinations or mixtures thereof. In some embodiments, hydroxyalkyl(meth)acrylates include hydroxyethyl(meth)acrylate, hydroxypropyl(meth)acrylate, hydroxybutyl(meth)acrylate, and/or mixtures thereof.

The monomeric curable material component of a composition described herein may also include a poly (ethylene glycol) diacrylate (PEGDA) component. With reference to the poly (ethylene glycol) diacrylate component as used herein, the PEGDA component can comprise a single poly (ethylene glycol) diacrylate species or multiple poly (ethylene glycol) diacrylate species of differing molecular weights. In some embodiments, species of the PEGDA component have a weight average molecular weight of 0.1 kiloDalton (kDa) to 20 kDa or 0.2 to 20 kDa. The molecular weight of individual species of PEGDA, for example, can fall within one or more ranges set forth in Table 1.

TABLE 1
Poly(ethylene glycol) Diacrylate Molecular Weight (kDa)

```
0.1-1
0.2-20
0.5-1
  3-5
  3-10
10-20
0.5-5
```

Any combination or mixture of poly (ethylene glycol) diacrylates of differing molecular weights is contemplated. In some embodiments, the PEGDA component comprises a mixture of two of more PEGDA species each having a weight average molecular weight from 0.5 to 5 kDa.

Additionally, in some cases, the monomeric curable material of a composition described herein comprises a cyclocarbonate (meth)acrylate monomer. In some such instances, the cyclocarbonate (meth)acrylate monomer has the structure of Formula I:

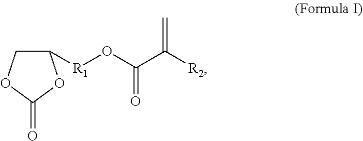

wherein R₁ is a linear or branched C₁-C₆ alkylene moiety; and
wherein R₂ is H or CH₃.

For reference purposes herein, it is to be understood that a “Cn-Cm alkylene moiety” (e.g., a “C₁-C₄ alkylene moiety”) is a bivalent saturated aliphatic radical having from “n” to “m” carbon atoms (e.g., 1 to 4 carbon atoms, and no more than 4 carbon atoms). In some preferred embodiments, R₁ is a linear or branched C₁-C₄ alkylene moiety, such as CH₂, which is especially preferred. Additionally, in some embodiments, R₂ is H. Further, in some instances, R₁ is CH₂ and R₂ is H. Thus, in some cases, the cyclocarbonate (meth)acrylate monomer of a composition described herein has the structure of Formula II:

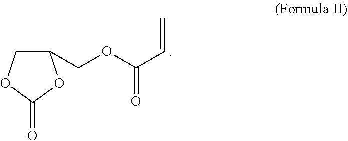

It is to be understood that the monomeric curable material of a composition described herein can include a combination of monomeric species, such as a combination of (meth)acrylate and/or (meth)acrylamide species described above. For example, in some cases, the monomeric curable material comprises one or more hydroxyalkyl(meth)acrylates, one or more poly (ethylene glycol)acrylates, one or more poly (ethylene glycol) diacrylates, one or more hydroxyalkyl(meth)acrylamides, one or more cyclocarbonate (meth)acrylates, or a combination of two or more of the foregoing. Thus, the present disclosure contemplates many combinations and compositions of the monomeric curable material that can be included in example implementations, though they are not explicitly enumerated herein.

In general, the monomeric curable material component of a composition described herein can be present in the composition in any amount not inconsistent with the technical objectives of the present disclosure. In some embodiments, for example, the monomeric curable material component is present in an amount or concentration of 1-90 wt. % or 5-80 wt. %, based on total weight of the composition. In some instances, the monomeric curable material component is present in an amount of 5-60 wt. %, 5-40 wt. %, 10-90 wt. %, 10-80 wt. %, 10-70 wt. %, 10-60 wt. %, 10-50 wt. %, 15-90 wt. %, 15-80 wt. %, 15-75 wt. %, 15-60 wt. %, 15-50 wt. %, 15-40 wt. %, 20-90 wt. %, 20-85 wt. %, 20-70 wt. %, 20-60 wt. %, 20-50 wt. %, 30-90 wt. %, 30-80 wt. %, 30-75 wt. %, 30-60 wt. %, 30-50 wt. %, 40-90 wt. %, 40-80 wt. %, 40-70 wt. %, 40-60 wt. %, 50-90 wt. %, 50-85 wt. %, 50-75 wt. %, 50-70 wt. %, 50-60 wt. %, 60-90 wt. %, 60-80 wt. %, 60-75 wt. %, 60-70 wt. %, 70-90 wt. %, 70-85 wt. %, 70-80 wt. %, or 75-90 wt. %, based on the total weight of the composition.

Compositions described herein also comprise an oligomeric curable material. Any oligomeric curable species not inconsistent with the technical objectives of the present disclosure may be used in the oligomeric curable material component. In some preferred embodiments, the oligomeric curable material comprises one or more hydrolysable oligomeric species. A “hydrolysable” oligomeric species, for reference purposes herein, includes at least one hydrolysable bond. In some cases, the hydrolysable bond is part of the repeating unit of the oligomer. For example, in some instances, a hydrolysable oligomeric species comprises one or more urethane bonds, one or more ester bonds, or one or more carbonate bonds in the backbone of the oligomeric species. As understood by one of ordinary skill in the art, such a bond may be hydrolyzed by water, including in a relatively facile manner when exposed to water or an aqueous solution described herein for a time period and at a temperature described herein.

Moreover, in some cases, the oligomeric curable material comprises an oligomeric species having two or more polymerizable moieties, such as two or more (meth)acrylate moieties. Further, in some preferred embodiments, oligomeric species of the oligomeric curable material component can be bifunctional or higher functional, as well as being hydrolysable. Additionally, in some preferred embodiments, a majority of the total amount of oligomeric curable material is bifunctional or higher functional. For example, in some cases, at least 60 wt. 9%, at least 70 wt. %, at least 80 wt. %, or at least 90 wt. % of the oligomeric curable material component is bifunctional or higher functional, where the foregoing weight percentages are based on the total amount of the oligomeric curable material component.

In some embodiments of a composition described herein, the oligomeric curable material comprises a urethane acrylate oligomer, a urethane methacrylate oligomer, a polyether urethane oligomer, an aliphatic polyester urethane acrylate oligomer, or a combination of two or more of the foregoing. Additionally, in some cases, the oligomeric curable material can comprise an aliphatic urethane diacrylate oligomer.

Some non-limiting examples of commercially available oligomeric curable materials useful in some embodiments described herein include the following: monofunctional urethane acrylate, commercially available from RAHN USA under the trade name GENOMER 1122; an aliphatic urethane diacrylate, commercially available from ALLNEX under the trade name EBECRYL 8402; an aliphatic urethane diacrylate oligomer, commercially available from IGM Resins under the trade name PHOTOMER 6210; an aliphatic urethane diacrylate oligomer, commercially available from IGM Resins under the trade name PHOTOMER 6710; a difunctional aliphatic polyether urethane acrylate oligomer, commercially available from BOMAR under the trade name BR-344; aliphatic polyether urethane acrylate, commercially available from DYMAX Corporation under the trade name BR-371S; polyether urethane methacrylate, commercially available from DYMAX Corporation under the trade name BR-541 MD; a difunctional aliphatic polyether urethane methacrylate oligomer, commercially available from BOMAR under the trade name BR-542 MB; a difunctional aliphatic polyether urethane methacrylate oligomer, commercially available from BOMAR under the trade name BR-543 MB; a trifunctional aliphatic polyester urethane acrylate, commercially available from BOMAR under the trade name BR-930D; a multifunctional acrylate oligomer, commercially available from DYMAX Corporation under the trade name BR-952; a difunctional aliphatic urethane acrylate, commercially available from BOMAR under the trade name BR-970BT; and a difunctional aliphatic urethane acrylate, commercially available from BOMAR under the trade name BR-970H. Other commercially available oligomeric curable materials may also be used.

Urethane (meth)acrylates suitable for use in build materials described herein, in some cases, can be prepared in a known manner, typically by reacting a hydroxyl-terminated urethane with acrylic acid or methacrylic acid to give the corresponding urethane (meth)acrylate, or by reacting an isocyanate-terminated prepolymer with hydroxyalkyl acrylates or methacrylates to give the urethane (meth)acrylate. Suitable processes are disclosed, inter alia, in EP-A 114 982 and EP-A 133 908. The weight average molecular weight of such (meth)acrylate oligomers, in some cases, can be from about 500 to 6,000. Urethane (meth)acrylates are also commercially available from SARTOMER under the product names CN980, CN981, CN975 and CN2901. In some embodiments, urethane acrylate oligomers are employed in compositions described herein. Suitable urethane acrylates can include difunctional aliphatic urethane acrylates from DYMAX Corporation under the trade designations BR-741 and BR-970. In some embodiments, an oligomeric curable material comprises aliphatic polyester urethane acrylate or aliphatic polyeyther urethane acrylate. Commercial examples of these oligomeric species are available from DYMAX Corporation under the trade designations BR-7432 and BR-543, respectively.

In still other embodiments, an oligomeric curable material component comprises a compound having the structure of Formula III or the structure of Formula IV:

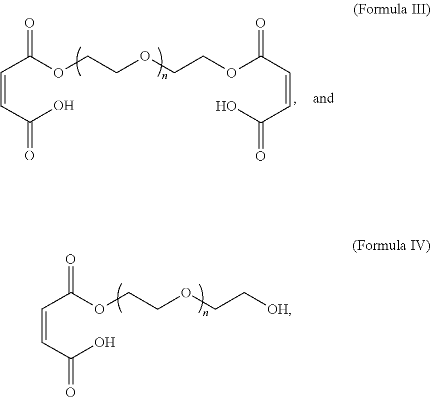

wherein n is an integer between 4 and 40 or between 4 and 20. In some implementations, such a compound has the structure of Formula III or Formula IV, wherein n is an integer between 4 and 14, between 4 and 20, between 6 and 30, between 10 and 40, or between 10 and 20. Other values of n are also possible. A compound of Formula III or Formula IV can be made in any manner not inconsistent with the technical objectives of the present disclosure. For example, in some cases, a compound described herein is formed from the reaction of a poly (ethylene glycol) (PEG) and maleic anhydride (MA). A species of Formula III can thus be referred to as “MA-PEG #-MA,” where “#” is the approximate weight average molecular weight of the PEG portion of the compound. For example, “MA-PEG200-MA” refers to a compound of Formula III wherein n has a value corresponding to a PEG moiety having a molecular weight of about 200.

The oligomeric curable material component can be present in a composition described herein in any amount not inconsistent with the technical objectives of the present disclosure. In some embodiments, for example, the oligomeric curable material component can be present in an amount of 1-40 wt. %, 1-35 wt. %, 1-30 wt. %, 1-25 wt. %, 1-20 wt. %, 1-15 wt. %, 1-10 wt. %, 5-40 wt. %, 5-35 wt. %, 5-30 wt. %, 5-25 wt. %, 5-20 wt. %, 5-15 wt. %, 5-10 wt. %, 10-40 wt. %, 10-35 wt. %, 10-30 wt. %, 10-25 wt. %, 10-20 wt. %, 15-40 wt. %, 15-35 wt. %, 15-30 wt. %, 15-25 wt. %, 20-40 wt. %, 20-35 wt. %, 20-30 wt. %, 25-40 wt. %, or 25-35 wt. %, based on the total weight of the composition.

Compositions described herein also comprise a chain transfer agent. A chain transfer agent, as understood by one of ordinary skill in the art, can control or reduce the degree or rate of polymerization of certain monomers. In some embodiments described herein, a chain transfer agent is reactive toward or can react with a polymerizable species of the composition (or a free radical version thereof) to form a radical that is more stable than the propagating radical of the polymerization reaction used to form the 3D article. However, in some cases, it is to be understood that the free radical formed by the chain transfer agent may not be as stable as a free radical formed by a polymerization inhibitor, such as butylated hydroxytoluene (BHT).

Any chain transfer agent not inconsistent with the technical objectives of the present disclosure may be used in a composition described herein. For example, in some embodiments, the chain transfer agent comprises one or more thiols. Moreover, a thiol species can comprise a plurality of thiol moieties. For example, in some instances, a chain transfer agent comprises two, three, or four thiol moieties.

In some embodiments, a chain transfer agent comprises an alkyl thiol, a thiol glycolate ester, or a thiol propionate ester. Moreover, in some instances, such an alkyl thiol, thiol glycolate ester, or thiol propionate ester comprises a plurality of thiol moieties, including at differing terminuses of the molecule.

In some cases, a chain transfer agent comprises a chemical species having the structure of Formula V, Formula VI, Formula VII, Formula VIII, or Formula IX:

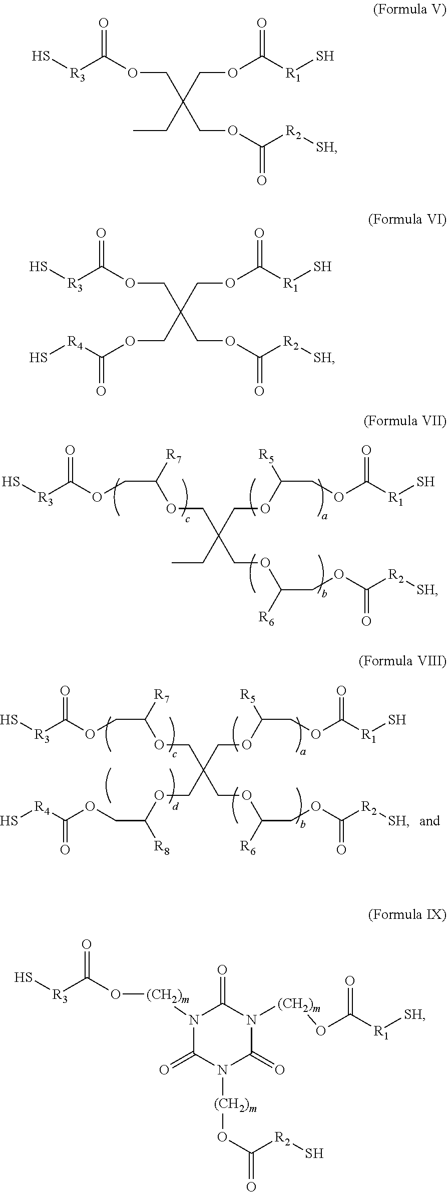

wherein R₁, R₂, R₃, and R₄ are each independently a linear or branched C1-C36 alkyl or alkylene, alkenyl or alkenylene, aryl or arylene, or heteroaryl or heteroarylene moiety; R₅, R₆, R₇, and R₈ are each independently H or CH₃; a, b, c, and d are each independently an integer from 1 to 100; and m is an integer from 1 to 36. For example, in some cases, one or more of R₁, R₂, R₃, and R₄ is CH₂ or CH₂CH₂; and R₅, R₆, R₇, and R₅ are each H.

Further, in some implementations described herein, a chain transfer agent comprises a reversible addition-fragmentation chain transfer agent, or RAFT agent, such as a thiocarbonylthio compound. In some such cases, the chain transfer agent comprises a dithioester, a thiocarbamate, a xanthate, or a combination of two or more of the foregoing.

Non-limiting examples of chain transfer agents suitable for use in some embodiments described herein include pentaerythritol tetra(3-mercaptopropionate) (PETMP) (commercially available from BRUNO BROCK under the trade name THIOCURE PETMP, PETMP 1.o., or PETMP sl), trimethylol-propane tri(3-mercaptopropionate) (TMPMP) (commercially available from BRUNO BOCK), glycol di(3-mercaptopropionate) (GDMP) (commercially available from BRUNO BOCK), pentaerythritol tetramercaptoacetate (PETMA) (commercially available from BRUNO BOCK), trimethylol-propane trimercaptoacetate (TMPMA) (commercially available from BRUNO BOCK), glycol dimercaptoacetate (GDMA) (commercially available from BRUNO BOCK), ethoxylated trimethylolpropane tri(3-mercaptopropionate) (ETTMP) (commercially available from BRUNO BOCK under the trade name ETTMP 700 or ETTMP 1300, depending on molecular weight), propyleneglycol 3-mercaptopropionate (PPGMP) (commercially available from BRUNO BOCK under the trade name PPGMP 800 or PPGMP 2200, depending on molecular weight), tris[2-(3-mercaptopropionyloxy) ethyl]isocyanurate (TEMPIC) (commercially available from BRUNO BOCK), polycaprolactone tetra 3-mercaptopropionate (commercially available from BRUNO BOCK under the trade name PCLAMP 1350), 2,3-di((2-mercaptoethyl) thio)-1-propane-thiol (DMPT) (commercially available from BRUNO BOCK), dimercaptodiethylsulfide (DMDS) (commercially available from BRUNO BOCK), pentacrythritol tetrakis(3-mercaptobutylate) (commercially available from SHOWA DENKO under the trade name KARENZ MT PEI), 1,4-bis(3-mercaptobutylyloxy) butane (commercially available from SHOWA DENKO under the trade name KARENZ MT BD1), and 1,3,5-tris (3-mercaptobutyloxethyl)-1,3,5-triazine-2,4,6 (1H,3H,5H)-trione (commercially available from SHOWA DENKO under the trade name KARENZ MT NR1). Other chain transfer agents may also be used in a composition described herein.

It is further to be understood that a chain transfer agent component of a composition described herein can comprise only one chemical species or a plurality of differing chemical species. For example, in some cases, the chain transfer agent of a composition described herein comprises a plurality of differing species. Any combination of differing species not inconsistent with the technical objectives of the present disclosure may be used in a composition described herein.

The chain transfer agent component can be present in a composition described herein in any amount not inconsistent with the technical objectives of the present disclosure. In some embodiments, for example, the chain transfer agent component can be present in an amount of 0.1-10 wt. %, 0.1-5 wt. %, 0.1-3 wt. %, 0.1-1 wt. %, 0.5-10 wt. %, 0.5-5 wt. %, 0.5-3 wt. %, 0.5-2 wt. %, 0.5-1.5 wt. %, 1-10 wt. %, 1-5 wt. %, or 1-3 wt. %, based on the total weight of the composition. In some preferred embodiments, the amount of chain transfer agent is less than 5 wt. %, less than 3 wt. %, or less than 1 wt. %, based on the total weight of the composition.

Compositions described herein, in some embodiments, also comprise a photoinitiator component for initiating polymerization of one or more components of the composition upon exposure to light of the proper wavelength. In some embodiments, the photoinitiator component can initiate polymerization of the monomeric curable material, the oligomeric curable material, and/or one or more additional polymerizable or curable material components of the composition.

Any photoinitiator not inconsistent with the objectives of the present disclosure may be used in a composition described herein. In some embodiments, for example, the photoinitiator component comprises an alpha-cleavage type (unimolecular decomposition process) photoinitiator or a hydrogen abstraction photosensitizer-tertiary amine synergist, operable to absorb light between about 250 nm and about 400 nm, between about 250 nm and 405 nm, or between about 300 nm and about 385 nm, to yield free radical(s). Examples of alpha cleavage photoinitiators are Irgacure 184 (CAS 947-19-3), Irgacure 369 (CAS 119313-12-1), and Irgacure 819 (CAS 162881-26-7). An example of a photosensitizer-amine combination is Darocur BP (CAS 119-61-9) with diethylaminoethylmethacrylate.

In addition, in some instances, photoinitiators comprise benzoins, including benzoin, benzoin ethers, such as benzoin methyl ether, benzoin ethyl ether and benzoin isopropyl ether, benzoin phenyl ether and benzoin acetate, acetophenones, including acetophenone, 2,2-dimethoxyacetophenone and 1,1-dichloroacetophenone, benzil, benzil ketals, such as benzil dimethyl ketal and benzil diethyl ketal, anthraquinones, including 2-methylanthraquinone, 2-ethylanthraquinone, 2-tert-butylanthraquinone, 1-chloroanthraquinone and 2-amylanthraquinone, triphenylphosphine, benzoylphosphine oxides, such as 2,4,6-trimethylbenzoyldiphenylphosphine oxide (Lucirin TPO), benzophenones, such as benzophenone and 4,4′-bis(N,N′-dimethylamino) benzophenone, thioxanthones and xanthones, acridine derivatives, phenazine derivatives, quinoxaline derivatives or 1-phenyl-1,2-propanedione, 2-O-benzoyl oxime, 1-aminophenyl ketones or 1-hydroxyphenyl ketones, such as 1-hydroxycyclohexyl phenyl ketone, phenyl 1-hydroxyisopropyl ketone and 4-isopropylphenyl 1-hydroxyisopropyl ketone.

Suitable photoinitiators can also comprise photoinitiators operable for use with a HeCd laser radiation source, including acetophenones, 2,2-dialkoxybenzophenones and 1-hydroxyphenyl ketones, such as 1-hydroxycyclohexyl phenyl ketone or 2-hydroxyisopropyl phenyl ketone (=2-hydroxy-2,2-dimethylacetophenone). Additionally, in some cases, suitable photoinitiators comprise those operable for use with an Ar laser radiation source including benzil ketals, such as benzil dimethyl ketal. In some embodiments, a suitable photoinitiator comprises an a-hydroxyphenyl ketone, benzil dimethyl ketal or 2,4,6-trimethylbenzoyldiphenylphosphine oxide or a mixture thereof.

Another class of photoinitiators that may be included in a composition described herein comprises ionic dye-counter ion compounds capable of absorbing actinic radiation and generating free radicals for polymerization initiation. In some embodiments, a composition containing ionic dye-counter ion compounds can be polymerized upon exposure to visible light within the adjustable wavelength range of about 400 nm to about 700 nm. Ionic dye-counter ion compounds and their mode of operation are disclosed in EP-A-0 223 587 and U.S. Pat. Nos. 4,751,102; 4,772,530; and 4,772,541.

In some cases, a photoinitiator that may be included in a composition described herein comprises a water-soluble pyrrolidone or phosphine oxide such as a monoacylphosphine oxide (MAPO) salt or bisacylphosphine oxide (BAPO) salt, which may in some instances be a sodium or lithium MAPO or BAPO salt. In some embodiments, a photoinitiator included in a composition described herein has a structure of Formula X or Formula XI:

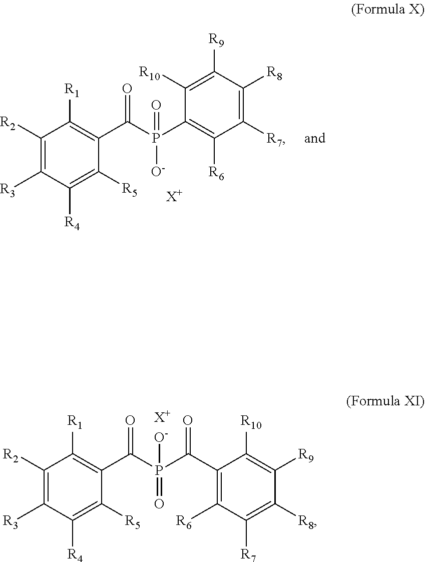

wherein X is Na or Li, and wherein each of R₁-R₁₀ is independently H, CH₃, or CH₂CH₃. For example, in some preferred embodiments, each of R₁, R₃, and R₅ in Formula X is CH₃, and each of R₂, R₄, R₆, R₇, R₈, R₉, and R₁₀ is H. Such a species can be referred to herein as “NaP”, “Na-TPO”, “Sodium TPO”, or “Sodium TPO-L” when X is Na, and as “LiP”, “Li-TPO”, “Lithium TPO”, or “Lithium TPO-L” when X is Li. In other preferred embodiments, each of R₁, R₃, R₅, R₆, R₈, and R₁₀ in Formula XI is CH₃, and each of R₂, R₄, R₇, and R₉ is H. Such a species can be referred to herein as BAPO-ONa when X is Na, and as BAPO-OLi when X is Li. It is further to be understood with reference to Formula X and Formula XI above that these structures also represent resonance structures, or structures in which (for drawing convenience) the P—O single bond and the P—O double bond “switch places” in the depiction of the structure (e.g., such that the P—O double bond points “up” like the two adjacent C—O double bonds in Formula XI, rather than pointing “down” as depicted above).

A photoinitiator component can be present in a composition described herein in any amount not inconsistent with the objectives of the present disclosure. In some embodiments, a photoinitiator component is present in a composition in an amount of up to about 7 wt. %, up to about 5 wt. %, up to about 3 wt. %, or up to about 2 wt. %, based on the total weight of the composition. In some cases, a photoinitiator is present in an amount of about 0.1-7 wt. %, 0.1-5 wt. %, 0.1-3 wt. %, 0.1-2 wt. %, 0.5-5 wt. %, 0.5-3 wt. %, 0.5-2 wt. %, 1-7 wt. %, 1-5 wt. %, or 1-3 wt. %, based on the total weight of the composition. In some especially preferred embodiments, a composition described herein comprises a photoinitiator component in an amount of up to about 5 wt. %. For example, in some instances, the photoinitiator component is present in the composition in an amount of 0.1-5 wt. % or 0.5-5 wt. % or, even more preferably, 1-5 wt. %, 1-3 wt. %, or 2-4 wt. %, based on the total weight of the composition.

It is further to be understood that the amounts (weight percents) described in the immediately preceding paragraph refer to photoinitiators that are non-oligomeric and non-polymeric. That is, the amounts described above refer to “monomeric” or “molecular” photoinitiators, which may, for instance, have a molecular weight of less than 400. However, it is also to be understood that oligomeric or polymeric photoinitiators may be used in compositions and methods described herein. But in such an instance (when an oligomeric or polymeric photoinitiator is used), then the amounts (weight percents) above are to be calculated without taking into account the weight of the oligomeric or polymeric portion or moiety of the oligomeric or polymeric photoinitiator. In other words, to determine the overall amount (weight percent) of the oligomeric or polymeric photoinitiator that is present in the composition, the calculation (specifically, the numerator) should be based on only the molecular weight of the photoactive moiety of the photoinitiator, not on the molecular weight(s) of the remaining moieties or repeating units of the oligomeric or polymeric photoinitiator (for purposes of the present disclosure).

Compositions described herein, in some cases, can further comprise one or more photosensitizers. In general, such a sensitizer can be added to a build material to increase the effectiveness of one or more photoinitiators that may also be present. In some cases, a sensitizer comprises isopropylthioxanthone (ITX) or 2-chlorothioxanthone (CTX).

A sensitizer can be present in a composition in any amount not inconsistent with the technical objectives of the present disclosure. In some embodiments, a sensitizer is present in an amount ranging from about 0.1 wt. % to about 2 wt. % or from about 0.5 wt. % to about 1 wt. %, based on the total weight of the composition. However, in other cases, a composition described herein excludes a sensitizer such as described above.

A composition described herein, in some embodiments, further comprises one or more stabilizers or inhibitors. It is to be understood that such a stabilizer or inhibitor, when present, is different than the chain transfer agent of the composition. A polymerization inhibitor or stabilizer can be added to a composition to provide additional thermal stability to the composition. Any polymerization inhibitor or stabilizer not inconsistent with the technical objectives of the present disclosure may be used. Moreover, a polymerization inhibitor or stabilizer can retard or decrease the rate of polymerization, and/or prevent polymerization from occurring for some period of time or “induction time” until the polymerization inhibitor or stabilizer is consumed. Further, in some cases, a polymerization inhibitor or stabilizer described herein is an “addition type” inhibitor, as opposed to a “chain transfer type” inhibitor. In some instances, a suitable polymerization inhibitor or stabilizer comprises methoxyhydroquinone (MEHQ) or butylated hydroxytoluene (BHT). In some embodiments, a stabilizer or inhibitor comprises an anti-oxidant.

A polymerization inhibitor and/or a stabilizer can be present in a composition in any amount not inconsistent with the technical objectives of the present disclosure. In some embodiments, an inhibitor or stabilizer is present in an amount ranging from about 0.01 wt. % to about 2 wt. % or from about 0.05 wt. % to about 1 wt. %, based on the total weight of the composition.

Turning to another possible component of a composition described herein, in some cases, a composition described herein further comprises one or more non-reactive polymers or oligomers. It is to be understood that a “non-reactive” polymer or oligomer does not have a functional group or moiety that participates in polymerization of a composition described herein. That is, a non-reactive polymer or oligomer does not become incorporated into the backbone of a polymerized or cured composition described herein, by means of covalent bonding. For instance, as described herein, a “non-reactive” polymer or oligomer generally does not comprise an ethylenenically unsaturated moiety, such as a (meth)acrylate or (meth)acrylamide moiety. Moreover, such a non-reactive polymer or oligomer, in some instances, can provide an emulsifying effect. Any non-reactive polymer or oligomer not inconsistent with the technical objectives of the present disclosure may be used in a composition described herein. In some embodiments, for example, a non-reactive polymer or oligomer comprises a sorbitan ester such as sorbitan monostearate, sorbitan triesterate, or sorbitan monolaurate; a polysorbate or ethoxylated sorbitan ester; a poly (ethylene glycol) (PEG); a poloxamer or amphiphilic block copolymer, such as a block copolymer comprising hydrophilic poly (ethylene oxide) (PEO) and hydrophobic poly (propylene oxide) (PPO) blocks (e.g., in an A-B-A structure); or a combination of two or more of the foregoing. Non-limiting examples of non-reactive polymers or oligomers suitable for use in some embodiments described herein include TWEEN 20, TWEEN 40, TWEEN 60, and TWEEN 80 (all commercially available from CRODA); SPAN 20, SPAN 60, SPAN 65, SPAN 83, and SPAN 85 (all commercially available from CRODA); PLURONIC L61, PLURONIC L64, PLURONIC L121, PLURONIC F127, PLURONIC F68, PLURONIC F87, PLURONIC P105, and PLURONIC P123 (all commercially available from BASF Corporation); and PEG 500, PEG 1000, PEG 1500, PEG 2000, PEG 2500, PEG 3000, and PEG 3500.

A non-reactive polymer or oligomer (or combination of two or more non-reactive polymers or oligomers) can be present in a composition in any amount not inconsistent with the technical objectives of the present disclosure. In some embodiments, a non-reactive polymer or oligomer (or combination of two or more non-reactive polymers or oligomers) is present in an amount ranging from about 0.5-50 wt. %, 0.5-40 wt. %, 0.5-35 wt. %, 0.5-30 wt. %, 0.5-25 wt. %, 0.5-20 wt. %, 0.5-15 wt. %, 0.5-10 wt. %, 0.5-5 wt. %, 1-50 wt. %, 1-40 wt. %, 1-35 wt. %, 1-30 wt. %, 1-25 wt. %, 1-20 wt. %, 1-15 wt. %, 1-10 wt. %, 1-5 wt. %, 5-50 wt. %, 5-40 wt. %, 5-35 wt. %, 5-30 wt. %, 5-25 wt. %, 5-20 wt. %, 5-15 wt. %, or 5-10 wt. %, based on the total weight of the composition.

Turning to still another possible component of a composition described herein, compositions described herein can also comprise at least one colorant. Such a colorant of a build material described herein can be a particulate colorant, such as a particulate pigment, or a molecular colorant, such as a molecular dye. Any such particulate or molecular colorant not inconsistent with the technical objectives of the present disclosure may be used. In some cases, for instance, the colorant of a composition comprises an inorganic pigment, such as TiO₂ and/or ZnO. In some embodiments, the colorant of a composition comprises a colorant for use in a RGB, SRGB, CMY, CMYK, L*a*b*, or Pantone® colorization scheme. Moreover, in some cases, a particulate colorant described herein has an average particle size of less than about 5 μm, or less than about 1 μm. In some instances, a particulate colorant described herein has an average particle size of less than about 500 nm, such as an average particle size of less than about 400 nm, less than about 300 nm, less than about 250 nm, less than about 200 nm, or less than about 150 nm. In some instances, a particulate colorant has an average particle size of about 50-5000 nm, about 50-1000 nm, or about 50-500 nm.

A colorant can be present in a composition described herein in any amount not inconsistent with the technical objectives of the present disclosure. In some cases, colorant is present in the composition in an amount up to about 2 wt. %, or an amount of about 0.005-2 wt. %, 0.01-2 wt. %, 0.01-1.5 wt. %, 0.01-1 wt. %, 0.01-0.5 wt. %, 0.1-2 wt. %, 0.1-1 wt. %, 0.1-0.5 wt. %, or 0.5-1.5 wt. %, based on the total weight of the composition. In some embodiments, a composition described herein excludes colorant as described above.

Compositions or materials described herein can have a variety of properties in a cured or uncured state, including properties related to the microstructure of the composition or material, which may be a complex mixture or other complex material system. In some embodiments, such structural features or other properties relate to the composition or material in a cured or polymerized state. A composition or material in a “cured” or “polymerized” state, as used throughout the present disclosure, comprises a composition or material that includes a curable material or polymerizable component that has been at least partially cured, i.e., at least partially polymerized and/or cross-linked. For instance, in some cases, a cured composition or material is at least about 70% polymerized or cross-linked or at least about 80% polymerized or cross-linked. In some embodiments, a cured composition or material is at least about 85%, at least about 90%, at least about 95%, at least about 98%, or at least 99% polymerized or cross-linked. In some instances, a cured composition or material is between about 80% and about 99% polymerized or cross-linked. The degree of polymerization or cross-linking can be determined using any protocol or method not inconsistent with the technical objectives of the present disclosure, such as by determining the percentage of monomers incorporated into the polymer network (e.g., based on molecular weight of the polymer compared to the molecular weight of the monomer, or based on the total polymer mass compared to the theoretical maximum of the total polymer mass) or by determining the amount of unincorporated monomers. When more than one method is used to determine a degree of polymerization or cross-linking, the results of the methods can be averaged to obtain a percentage described herein. It is further to be understood that the degree of polymerization or cross-linking described herein is different than “degree of polymerization” defined as the number of repeating units in a polymer molecule.

In some embodiments, a composition described herein when cured or polymerized has a tensile strength of greater than 40 MPa when determined according to ASTM D638. For example, certain articles formed from polymerization of a composition in accordance with the present disclosure can have a tensile strength of 40-70 MPa, when measured according to ASTM D638.

Further, in some embodiments, a composition described herein, when cured, exhibits a glass transition temperature (T_{g}) of at least 50° C., at least 70° C., at least 90° C., at least 100° C., at least 105° C., at least 110° C., or at least 115° C., when measured using DMA as the maximum of tan delta. In some cases, a composition described herein, when cured, exhibits a T_{g} of 50° C. to 250° C., 50° C. to 200° C., 50° C. to 170° C., 50° C. to 150° C., 50° C. to 130° C., 50° C. to 125° C., 50° C. to 100° C., 70° C. to 250° C., 70° C. to 200° C., 70° C. to 170° C., 70° C. to 150° C., 70° C. to 130° C., 70° C. to 125° C., 70° C. to 100° C., 90° C. to 250° C., 90° C. to 200° C., 90° C. to 170° C., 90° C. to 150° C., 90° C. to 130° C., 90° C. to 125° C., 100° C. to 250° C., 100° C. to 200° C., 100° C. to 170° C., 100° C. to 150° C., 100° C. to 130° C., 100° C. to 125° C., 105° C. to 250° C., 105° C. to 220° C., 105° C. to 200° C., 105° C. to 180° C., 105° C. to 160° C., 105° C. to 140° C., 105° C. to 125° C., 110° C. to 250° C., 110° C. to 220° C., 110° C. to 200° C., 110° C. to 180° C., 110° C. to 160° C., 110° C. to 140° C., 110° C. to 125° C., 115° C. to 250° C., 115° C. to 220° C., 115° C. to 200° C., 115° C. to 180° C., 115° C. to 160° C., 115° C. to 140° C., 115° C. to 125° C., 125° C. to 250° C., 125° C. to 220° C., 125° C. to 200° C., 125° C. to 180° C., 125° C. to 160° C., 125° C. to 140° C., 150° C. to 250° C., 150° C. to 220° C., 150° C. to 200° C., or 150° C. to 180° C., when measured as noted above. In a preferred embodiment, a composition described herein has a T_{g} of 105° C. to 125° C.

Moreover, in some instances, a composition described herein, when cured, does not start to flow (e.g., as detectable by the unaided eye of a healthy human observer) under normal gravity at a temperature below 200° C., below 220° C., below 250° C., below 270° C., or below 300° C. In some cases, a composition described herein, when cured, starts to flow under normal gravity at a temperature of 200-350° C., 200-300° C., 200-250° C., 220-350° C., 220-300° C., 220-250° C., 270-350° C., 270-300° C., or 300-350° C. In some embodiments, a composition described herein does not deform under its own weight under normal gravity at a temperature below 200° C., below 220° C., below 250° C., below 270° C., or below 300° C. Further, in some embodiments, a composition described herein exhibits monotonic thermal expansion (based on the measured coefficient of thermal expansion) up to 200° C., up to 220° C., up to 250° C., up to 270° C., or up to 300° C. In some instances, a composition described herein exhibits monotonic thermal expansion (based on the measured coefficient of thermal expansion) throughout a temperature range of 100-350° C., 100-300° C., 100-250° C., 100-200° C., 150-350° C., 150-300° C., 150-250° C., 150-200° C., 170-350° C., 170-300° C., 170-250° C., 200-350° C., 200-300° C., or 200-250° C.

Additionally, in some embodiments, compositions described herein, when non-cured, have a viscosity profile consistent with the requirements and parameters of one or more 3D printing systems, such as an MJP, SLA, or DLP system. For example, in some cases, a composition described herein has a dynamic viscosity at 23° C. or 30° C. of 1600 centipoise (cP) or less, 1200 cP or less, or 800 cP or less. In a preferred embodiment, a composition described herein has a dynamic viscosity of 500 cP or less at 23° C. or 30° C., when measured according to ASTM standard D2983 (e.g., using a Brookfield Model DV-II+ Viscometer). In some cases, a composition described herein when non-cured exhibits a dynamic viscosity of about 100-1600 cP, about 100-1200 cP, about 100-1000 cP, about 100-800 cP, about 100-500 cP, about 100-400 cP, about 200-1600 cP, about 200-1200 cP, about 200-1000 cP, about 200-800 cP, about 200-500 cP, or about 200-400 cP at 23° C. or 30° C., when measured according to ASTM D2983. Further, in some cases, a composition described herein, in an uncured state, has a dynamic viscosity of 5 cP to 30 cP or 8 cP to 14 cP at a temperature of 80° C., when determined according to ASTM D2983.

Compositions described herein can also include, have, or exhibit any combination of components and/or properties described hereinabove individually, provided that the combination of components and/or properties is not inconsistent with the principles and technical objectives of the present invention. Moreover, in some embodiments, compositions described herein have a combination of compositional characteristics that can be especially preferred for providing improved heat resistance, solubility or dispersibility, and/or strength.

For example, in some instances, a composition described herein has a combination of characteristics set forth in Table 2 below.

TABLE 2
Example Composition Characteristics

| | | | | | Soluble or |
|---|---|---|---|---|---|
| | | | Dynamic | Dynamic | Dispersible |
| | Tensile | | Viscosity | Viscosity | in Water or |
| | Strength, | T_{g}, | at 23° C., | at 80° C., | Aqueous |
| Combina- | cured | cured | uncured | uncured | Solution at |
| tion | (MPa) | (° C.) | (cP) | (cP) | 25° C., cured |
| 1 | 40-70 | 50-250 | 100-1000 | 5-30 | Yes |
| 2 | 40-60 | 100-125 | 100-500 | 5-20 | Yes |
| 3 | 40-65 | 50-100 | 100-500 | 5-15 | Yes |
| 4 | 40-70 | 105-125 | 100-400 | 5-20 | Yes |
| 5 | 50-70 | 110-140 | <500 | 5-20 | Yes |
| 6 | 40-70 | 110-130 | 100-800 | 8-14 | Yes |
| 7 | 45-70 | 115-125 | <500 | 5-20 | Yes |
| 8 | 40-70 | 115-140 | 100-500 | 5-30 | Yes |
| 9 | 50-70 | 110-130 | 100-500 | 5-15 | Yes |
| 10 | 40-65 | 105-130 | 100-800 | 5-30 | Yes |

Compositions described herein can be produced in any manner not inconsistent with the technical objectives of the present disclosure. In some embodiments, for instance, a method for the preparation of a composition described herein comprises the steps of mixing the components of the composition, optionally melting the mixture, and filtering the (optionally molten) mixture. In some cases, the components are mixed and optionally melted at a temperature between about 25° C. and about 35° C., or at a temperature in the range of 25-55° C., 35-65° C., or 45-75° C. In some instances in which it is desirable or necessary to melt one or more solid components of the composition, mixing and/or melting can be carried out at a temperature in a range from about 75° C. to about 85° C. In some embodiments, a composition described herein is produced by placing all components of the composition in a reaction vessel, optionally heating the resulting mixture, and stirring the resulting mixture at a temperature between about 25° C. and about 75° C. or at a temperature ranging from about 75° C. to about 85° C. The stirring (and optionally the heating) are continued until the mixture attains a substantially homogenized liquid (or molten) state. In general, the liquid (or molten) mixture can be filtered while in a flowable state to remove any large undesirable particles that may interfere with jetting or extrusion or other printing process. The filtered mixture can then be cooled to ambient temperatures (if cooling is needed) and stored until ready for use in a 3D printing system.

### II. Methods of Forming a 3D Article by Additive Manufacturing

In another aspect, methods of forming or “printing” a 3D article or object by additive manufacturing are described herein. Methods of forming a 3D article or object described herein can include forming the 3D article from a plurality of layers of a composition described herein in a layer-by-layer manner. In such cases, the composition can be used as a build material. It is also possible, in some embodiments, to use a composition described herein as a support material. Methods of forming a 3D article by additive manufacturing can also include forming the object in a manner other than a layer-by-layer manner. Any composition described hereinabove in Section I may be used in a method described herein. For example, in some embodiments, a method described herein comprises providing a composition, wherein the composition comprises a monomeric curable material, an oligomeric curable material, a chain transfer agent, and optionally a non-reactive polymer or oligomer. Further, in some such cases, the monomeric curable material comprises one or more (meth)acrylates and/or one or more (meth)acrylamides. Additionally, in some instances, the oligomeric curable material comprises one or more hydrolysable oligomeric species.

In some cases, a method described herein comprises providing a build material comprising a composition described above, and selectively curing a portion of the build material using incident curing radiation having a Gaussian distribution of wavelengths and a peak wavelength at the wavelength 2. Moreover, in some embodiments described herein, the build material is selectively cured according to a digital file or image of the desired article, such as according to preselected computer aided design (CAD) parameters. Moreover, in some cases, one or more layers of a build material described herein has a thickness of about 10 μm to about 100 μm, about 10 μm to about 80 μm, about 10 μm to about 50 μm, about 10 μm to about 40 μm, about 20 μm to about 100 μm, about 20 μm to about 80 μm, or about 20 μm to about 40 um. Other thicknesses are also possible.

Performing a printing process described herein can provide a printed 3D article from a build material described herein that has a high feature resolution. The “feature resolution” of an article, for reference purposes herein, can be the smallest controllable physical feature size of the article or the pixel or voxel size of the printing process, where it is understood that “pixel” and “voxel” refer to the CAD parameter or other digital model of the article. In some embodiments, a printed article described herein has an average voxel size greater than 50 μm per side on average (e.g., when the average voxel size corresponds to a volume having an average length in all three dimensions of 50-100 μm, 50-75 μm, 60-100 μm, 60-80 μm, or 60-70 μm). In other cases, a printed article described herein has an average voxel size of less than 50 μm, less than 40 μm, less than 30 μm, or less than 20 μm per side on average (e.g., when the average voxel size corresponds to a volume having an average length in all three dimensions of 10-45 μm, 10-40 μm, 10-30 μm, 10-25 μm, 10-20 μm, 15-45 μm, or 15-40 μm).

Additionally, it is to be understood that methods of printing a 3D article described herein can include, for example, MJP, DLP, or SLA 3D printing methods. For example, in some instances, a MJP method of printing a 3D article comprises selectively depositing layers of a build material described herein in a fluid state onto a substrate, such as a build pad of a 3D printing system. In addition, in some embodiments, a method described herein further comprises supporting at least one of the layers of the build material with a support material. Any support material not inconsistent with the objectives of the present disclosure may be used.

A method described herein can also comprise curing the layers of the build material, including with curing radiation described above (such as curing radiation having a peak wavelength 2). Moreover, curing can comprise polymerizing one or more polymerizable moieties or functional groups of one or more components of the build material. In some cases, a layer of deposited build material is cured prior to the deposition of another or adjacent layer of build material. Additionally, curing one or more layers of deposited build material, in some embodiments, is carried out by exposing the one or more layers to electromagnetic radiation, such as UV light, visible light, or infrared light, as described above.

It should further be noted that a wavelength 2 used to cure a material according to a method described herein can be any wavelength not inconsistent with the objectives of the present disclosure. For example, in some cases, A is a wavelength in the ultraviolet (UV) or visible region of the electromagnetic spectrum. In some cases, the peak wavelength 2 is in the infrared (IR) region of the electromagnetic spectrum. In some embodiments, the wavelength 2 is between 250 nm and 400 nm, between 300 nm and 385 nm, or between 385 nm and 405 nm. In other cases, the wavelength λ is between 600 nm and 800 nm or between 900 nm and 1.3 μm. However, the precise wavelength λ is not particularly limited.

Further details regarding various methods, including “material deposition” methods (such as MJP) or “vat polymerization” methods (such as SLA), are provided below.

### A. Material Deposition Methods

In a material deposition method, one or more layers of a build material described herein are selectively deposited onto a substrate and cured. Curing of the build material may occur after selective deposition of one layer, each layer, several layers, or all layers of the build material.

In some instances, a build material described herein (e.g., a composition described hereinabove in Section I) is selectively deposited in a fluid state onto a substrate, such as a build pad of a 3D printing system. Selective deposition may include, for example, depositing the build material according to preselected CAD parameters or other parameters corresponding to a digital image of the desired 3D article. For example, in some embodiments, a CAD file drawing (or other file or digital representation) corresponding to a desired 3D article to be printed is generated and sliced into a sufficient number of horizontal slices. Then, the build material is selectively deposited, layer by layer, according to the horizontal slices of the CAD file drawing (or other file or digital representation) to print the desired 3D article. A “sufficient” number of horizontal slices is the number necessary for successful printing of the desired 3D article, e.g., to produce it accurately and precisely.

Further, in some embodiments, a preselected amount of build material described herein is heated to the appropriate temperature and jetted through a print head or a plurality of print heads of a suitable inkjet printer to form a layer on a print pad in a print chamber. In some cases, each layer of build material is deposited according to preselected CAD parameters or other preselected parameters based on a digital file, image, or model of the desired article. A suitable print head to deposit the build material, in some embodiments, is a piezoelectric print head. Additional suitable print heads for the deposition of build material and support material described herein are commercially available from a variety of ink jet printing apparatus manufacturers. For example, Xerox, Hewlett Packard, or Ricoh print heads may be used in some instances.

Additionally, in some embodiments, a build material described herein remains substantially fluid upon deposition. Alternatively, in other instances, the build material exhibits a phase change upon deposition and/or solidifies upon deposition. Moreover, in some cases, the temperature of the printing environment can be controlled so that the jetted droplets of build material solidify on contact with the receiving surface. In other embodiments, the jetted droplets of build material do not solidify on contact with the receiving surface, remaining in a substantially fluid state. Additionally, in some instances, after each layer is deposited, the deposited material is planarized and cured with electromagnetic (e.g., UV, visible, or infrared light) radiation prior to the deposition of the next layer. Optionally, several layers can be deposited before planarization and curing, or multiple layers can be deposited and cured followed by one or more layers being deposited and then planarized without curing. Planarization corrects the thickness of one or more layers prior to curing the material by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the jetted build material described herein prior to curing, in some embodiments, should desirably be sufficient to retain its shape and not be subject to excessive viscous drag from the planarizer.

Moreover, a support material, when used, can be deposited in a manner consistent with that described hereinabove for the build material. The support material, for example, can be deposited according to the preselected CAD parameters (or other parameters described herein) such that the support material is adjacent or continuous with one or more layers of the build material. Jetted droplets of the support material, in some embodiments, solidify or freeze on contact with the receiving surface. In some cases, the deposited support material is also subjected to planarization, curing, or planarization and curing. Any support material not inconsistent with the objectives of the present disclosure may be used.

Layered deposition of the build material and support material can be repeated until the 3D article has been formed. In some embodiments, a method of printing a 3D article further comprises removing the support material from the build material. The support material can be removed in any manner not inconsistent with the technical objectives of the present disclosure. In some cases, for instance, removing the support material comprises melting the support material. In some such embodiments, the support material has a melting point that is at least 20° C., at least 30° C., at least 40° C., at least 50° C., at least 70° C., or at least 100° C. lower than a melting point, softening point, heat deflection temperature (HDT), or T_{g} of the build material. In some such cases, the support material comprises or is formed from a wax. Moreover, in some preferred embodiments described herein, the support material is not removed by dissolving or dispersing the support material in water or using an aqueous solution described herein.

Curing of the build material may occur after selective deposition of one layer of build material, of each layer of build material, of several layers of build material, or of all layers of the build material necessary to print the desired 3D article. In some embodiments, a partial curing of the deposited build material is performed after selective deposition of one layer of build material, each layer of build material, several layers of build material, or all layers of the build material necessary to print the desired 3D article. A “partially cured” build material, for reference purposes herein, is one that can undergo further curing. For example, a partially cured build material is up to about 30% polymerized or cross-linked or up to about 50% polymerized or cross-linked. In some embodiments, a partially cured build material is up to about 60%, up to about 70%, up to about 80%, up to about 90%, or up to about 95% polymerized or cross-linked.

Partial curing of the deposited build material can include irradiating the build material with an electromagnetic radiation source or photocuring the build material (including with curing radiation described hereinabove). Any electromagnetic radiation source not inconsistent with the objectives of the present disclosure may be used, e.g., an electromagnetic radiation source that emits UV, visible or infrared light. For example, in some embodiments, the electromagnetic radiation source can be one that emits light having a wavelength from about 300 nm to about 900 nm, e.g., a Xe arc lamp.

Further, in some embodiments, a post-curing is performed after partially curing is performed. For example, in some cases, post-curing is carried out after selectively depositing all layers of the build material necessary to form a desired 3D article, after partially curing all layers of the build material, or after both of the foregoing steps have been performed. Moreover, in some embodiments, post-curing comprises photocuring, including with curing radiation described hereinabove having a peak wavelength 2. Again, any electromagnetic radiation source not inconsistent with the objectives of the present disclosure may be used for a post-curing step described herein. For example, in some embodiments, the electromagnetic radiation source can be a light source that has a higher energy, a lower energy, or the same energy as the electromagnetic radiation source used for partial curing. In some cases wherein the electromagnetic radiation source used for post-curing has a higher energy (i.e., a shorter wavelength) than that used for partial curing, a Xe arc lamp can be used for partial curing and a Hg lamp can be used for post-curing.

Additionally, after post-curing, in some cases, the deposited layers of build material are at least about 80% polymerized or cross-linked or at least about 85% polymerized or cross-linked. In some embodiments, the deposited layers of build material are at least about 90%, at least about 95%, at least about 98%, or at least about 99% polymerized or cross-linked. In some instances, the deposited layers of build material are about 80-100%, about 80-99%, about 80-95%, about 85-100%, about 85-99%, about 85-95%, about 90-100%, or about 90-99% polymerized or cross-linked.

### B. Vat Polymerization Methods

It is also possible to form a 3D article from a build material described herein using a vat polymerization method, such as an SLA method. Thus, in some cases, a method of printing a 3D article described herein comprises retaining a build material described herein in a fluid state in a container and selectively applying energy (particularly, for instance, the curing radiation having the peak wavelength 2) to the build material in the container to solidify at least a portion of a fluid layer of the build material, thereby forming a solidified layer that defines a cross-section of the 3D article. Additionally, a method described herein can further comprise raising or lowering the solidified layer of build material to provide a new or second fluid layer of unsolidified build material at the surface of the fluid build material in the container, followed by again selectively applying energy (e.g., the curing radiation) to the build material in the container to solidify at least a portion of the new or second fluid layer of the build material to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the build material. Moreover, in some instances, the electromagnetic radiation has an average wavelength of 300-900 nm, and in other embodiments the electromagnetic radiation has an average wavelength that is less than 300 nm. In some cases, the curing radiation is provided by a computer controlled laser beam or other light source. In addition, in some cases, raising or lowering a solidified layer of build material is carried out using an elevator platform disposed in the container of fluid build material. A method described herein can also comprise planarizing a new layer of fluid build material provided by raising or lowering an elevator platform. Such planarization can be carried out, in some cases, by a wiper or roller.

It is further to be understood that the foregoing process can be repeated a desired number of times to provide the 3D article. For example, in some cases, this process can be repeated “n” number of times, wherein n can be up to about 100,000, up to about 50,000, up to about 10,000, up to about 5000, up to about 1000, or up to about 500. Thus, in some embodiments, a method of printing a 3D article described herein can comprise selectively applying energy (e.g., curing radiation of peak wavelength λ) to a build material in a container to solidify at least a portion of an nth fluid layer of the build material, thereby forming an nth solidified layer that defines an nth cross-section of the 3D article, raising or lowering the nth solidified layer of build material to provide an (n+1)th layer of unsolidified build material at the surface of the fluid build material in the container, selectively applying energy to the (n+1)th layer of build material in the container to solidify at least a portion of the (n+1)th layer of the build material to form an (n+1)th solidified layer that defines an (n+1)th cross-section of the 3D article, raising or lowering the (n+1)th solidified layer of build material to provide an (n+2)th layer of unsolidified build material at the surface of the fluid build material in the container, and continuing to repeat the foregoing steps to form the 3D article. Further, it is to be understood that one or more steps of a method described herein, such as a step of selectively applying energy (e.g., curing radiation described herein) to a layer of build material, can be carried out according to an image of the 3D article in a computer-readable format. General methods of 3D printing using stereolithography are further described, inter alia, in U.S. Pat. Nos. 5,904,889 and 6,558,606.

In a vat polymerization method such as described above, the build material may be partially cured as described in Section IIA above. For example, in some embodiments, selectively applying energy to the build material in the container to solidify at least a portion of a fluid layer of the build material may include partially curing at least a portion of a fluid layer of the build material. In other embodiments, partial curing of at least a portion of a fluid layer of the build material may occur after a first layer of the build material is provided and solidified, before or after a second layer of the build material is provided or solidified, or before or after one, several, or all subsequent layers of the build material are provided or solidified.

Additionally, in some embodiments of a vat polymerization method described herein, after partial curing or after the desired 3D article is formed, post-curing as described in Section IIA above may be performed. The desired 3D article may be, for example, an article that corresponds to the design in a CAD file or other digital file, image, or model corresponding to the desired 3D article.

### III. Printed 3D Articles

In another aspect, printed 3D articles are described herein. In some embodiments, a printed 3D article is formed from a composition described herein and/or using a method of additive manufacturing described herein. Any composition described hereinabove in Section I may be used. For example, in some cases, the composition comprises a monomeric curable material, an oligomeric curable material, and a chain transfer agent. Further, in some such cases, the monomeric curable material comprises one or more (meth)acrylates and/or one or more (meth)acrylamides. Additionally, in some instances, the oligomeric curable material comprises one or more hydrolysable oligomeric species. Similarly, any method described hereinabove in Section II may be used to form an article according to the present disclosure.

A composition and/or method according to the present disclosure can be used to form a variety of articles by additive manufacturing, without particular limitation. Similarly, articles printed according to methods described herein can find application in a variety of fields. However, in some preferred embodiments, the article is a mold, such as an eggshell mold for use in molding applications, such as injection molding or eggshell molding. In some such embodiments, the eggshell mold has an average wall thickness of 10 mm or less, or 5 mm or less. In some cases, the eggshell mold has an average wall thickness of 1-10 mm or 1-5 mm. Other articles can also be formed by a method of additive manufacturing described herein.

### IV. Methods of Forming a 3D Article by Molding

In another aspect, methods of forming a 3D article by molding are described herein. In some embodiments, such a method comprises providing a mold defining an interior volume and injecting a fluid material into the interior volume of the mold. In some cases, the method further comprises solidifying the fluid material within the interior volume of the mold to form the article and subsequently removing the mold from the formed article. It is to be understood that the mold can comprises or be formed from a composition described herein. Any composition described hereinabove in Section I may be used. Moreover, in some cases, providing the mold comprises forming the mold using additive manufacturing, including using a 3D printing method described hereinabove in Section II.

Further, the use of a composition described herein to form a mold, in some instances, can permit injection of fluid materials at relatively high temperature. For example, in some embodiments, the fluid material is injected at a temperature of at least 100° C., at least 150° C., at least 200° C., at least 220° C., at least 250° C., at least 270° C., or at least 300° C. In addition, use of a composition described herein may also permit facile removal of the mold following solidification of the fluid material within the mold. For instance, in some embodiments of a method described herein, removing the mold from the article comprises dissolving or dispersing the mold in water or an aqueous solution.

Turning now in more detail to certain steps of methods described herein, methods described herein comprise providing a mold defining an interior volume. The mold can have any interior volume not inconsistent with the objectives of the present disclosure. For example, in some cases, the mold has an interior volume of 0.5-100 L, 0.5-50 L, 0.5-25 L, 0.5-10 L, 1-100 L, 1-50 L, 1-10 L, 5-100 L, 5-50 L, 5-20 L, 10-100 L, or 10-50 L. Moreover, the mold and its interior volume can have any shape not inconsistent with the technical objectives of the present disclosure. In some instances, the interior volume has a shape corresponding to the exterior surface of the molded article to be formed by a method described herein.

A method described herein also comprises injecting a fluid material into the interior volume. The fluid material can be injected in any manner not inconsistent with the technical objectives of the present disclosure. For example, in some cases, the fluid material is injected at high pressure, such as a pressure of 50-150 MPa or 70-115 MPa. Lower pressures may also be used. Any equipment known to those of ordinary skill in the art may be used to inject a fluid material into an interior volume described herein. Additionally, in some instances, the fluid material is injected at an elevated temperature, such as a temperature of at least 100° C., at least 150° C., at least 200° C., at least 220° C., at least 250° C., at least 270° C., or at least 300° C. In some cases, the injection temperature is 100-350° C., 100-300° C., 100-250° C., 100-220° C., 100-200° C., 200-350° C., or 250-350° C., 150-350° C., 150-300° C., 150-250° C., 150-220° C., 150-200° C., 200-350° C., or 250-350° C. Other temperatures may also be used. Moreover, in some embodiments, the injection temperature is within 30° C., within 20° C., or within 10° C. of a melting point of the material that is injected into the interior volume of the mold, where it is to be understood that the melting point of the material is generally lower than the injection temperature (e.g., 1-30° C. lower, 1-20° C. lower, or 1-10° C. lower).

In addition, any fluid material not inconsistent with technical objectives of the present disclosure may be used in a method described herein. In some embodiments, for example, the fluid material comprises a polymeric material, such as a polyurethane (in some cases including a two-part polyurethane, comprising a “part A” such as polol part and a “part B” such as a polyisocyanate part), a polyamide (such as a nylon), a polyalkylene (such as a polypropylene or a polyethylene), or a polyethylene terephthalate (PET). In some cases, the fluid material comprises a polystyrene (such as a high impact polystyrene (HIPS)), a polybutadiene, a poly-acrylonitrile, a polyacrylate, or a copolymer of two more of the foregoing, such as an acrylonitrile butadiene styrene (ABS) or an acrylonitrile styrene acrylate (ASA). In some embodiments, the fluid material comprises a silicone or siloxane, such as polydimethylsiloxane (PDMS). Additionally, in some cases, the fluid material comprises a polyether ether ketone (PEEK). In other instances, the fluid material comprises a metallic material, such as an elemental metal or a combination, mixture, or alloy of metals. In some non-limiting example embodiments, the fluid material comprises pewter. In some cases, the fluid material comprises or is tin. Alternatively, in some instances, the fluid material does not comprise or is not formed from tin (by itself, as opposed to in an alloy or combination or mixture of metals).

Methods described herein, in some cases, further comprise solidifying the fluid material within the mold, after injecting the fluid material into the mold. Such solidification can be carried out in any manner not inconsistent with the technical objectives of the present disclosure. In some embodiments, for example, solidifying the fluid material comprises cooling the fluid material below a melting point of the fluid material (e.g., a melting point described hereinabove).

Additionally, in some preferred embodiments, a method of forming a 3D article by molding further comprises removing the mold from the article following solidification of the fluid material to form the article. The mold can be removed in any manner not inconsistent with the technical objectives of the present disclosure. In some cases, for example, removing the mold comprises dissolving or dispersing the mold in water or an aqueous solution. It is further to be understood that the water (or aqueous solution), in some cases, can have a basic pH or an acidic pH. For instance, in some cases, the water or aqueous solution used to remove the mold has a pH of about 5 to about 7. In some preferred embodiments, the water or aqueous solution used to remove the mold has a pH of about 7 to 14, 7 to 13, 7 to 12, 7 to 10, 8 to 14, 8 to 13, 8 to 12, or 8 to 10. As understood by one of ordinary skill in the art, such a pH can be obtained, for example, by in the inclusion of a Bronsted-Lowry acid or base. For instance, in some cases, a strong acid or a strong base such as hydrochloric acid or sodium hydroxide, respectively, may be included in water (or aqueous solution) in a desired concentration to provide the desired pH, as understood by a person of ordinary skill. In some embodiments, for example, a strong acid or strong base may be used at a concentration of up to 50%, up to 40%, up to 30%, up to 20%, up to 15%, or up to 10%. Other proton or hydroxide sources may also be used.

Moreover, in some embodiments, removing the mold comprises immersing the mold (and the molded article contained therein) in water or aqueous solution (e.g., in a container). Further, in some cases, the mold (and the article within) is immersed for a specific time period at a specific temperature. For example, in some embodiments, the mold is immersed for 0.5-1 day, 1-5 days, or 1-3 days at a temperature of 25-50° C., 25-45° C., 25-40° C., 30-50° C., 30-45° C., or 35-40° C. Further, in some cases, the immersion takes place at a pH described above. In one non-limiting embodiment, for instance, immersion occurs for 3 days at 40° C. in 5% NaOH.

Moreover, in some embodiments, agitation is used in addition to exposing the mold to water or an aqueous solution. Such agitation may be provided, in some instances, by mechanical shaking or stirring or by sonication.

### V. Molded 3D Articles

In another aspect, molded 3D articles are described herein. In some embodiments, a molded 3D article is formed from a method described hereinabove in Section IV, using a mold formed from a composition described hereinabove in Section I. Moreover, in some cases, the mold is formed using a method described hereinabove in Section II. An article formed by a molding process described herein can have any size, shape, and composition not inconsistent with the objectives of the present disclosure, and these features are not particularly limited. In some embodiments, for example, the molded article is formed from an injected material described hereinabove in Section IV, such as a polymer or a metal.

### EXAMPLES

Some embodiments of compositions described herein are further illustrated in the following non-limiting Examples, with reference to Tables 3-5. The amounts in Tables 3 and 5 refer to the wt. % of each component of the identified composition, based on the total weight of the composition. It is to be understood that all components of a given composition add up to 100 weight percent. Additional component information is provided in Table 4 and elsewhere below. In Tables 3-5, “Mono.” stands for “monomeric curable material”; “Olig.” stands for “oligomeric curable material”; “CTA” stands for “chain transfer agent”; “PI” stands for “photoinitiator”; “NRPO” stands for non-reactive polymer or oligomer; “Sens.” stands for “sensitizer”; and “Stab.” stands for “stabilizer”. Dashes (--) indicate a component is absent (zero weight percent).

Examples 1-9 were prepared by combining the identified components in the identified amounts, as shown in Tables 3 and 4, with mixing as described hereinabove. Examples 10-23 are similarly prepared, using the identified components and amounts shown in Table 5.

TABLE 3
Example Compositions

| Example | Mono. | Olig. | CTA | PI | NRPO | Stab. |
|---|---|---|---|---|---|---|
| 1 | 64.2 | 5.3 | 1.1 | 2.7 | 26.7 | — |
| 2 | 63.5 | 5.3 | 2.1 | 2.6 | 26.5 | — |
| 3 | 60.3 | 10.1 | 2 | 2.5 | 25.1 | — |
| 4 | 79.9 | 1 | 1 | 2.9 | 14.7 | 0.5 |
| 5 | 76.5 | 5 | 1 | 2 | 15 | 0.5 |
| 6 | 71.5 | 10 | 1 | 2 | 15 | 0.5 |
| 7 | 75.7 | 5 | 2 | 2 | 14.8 | 0.5 |
| 8 | 70.8 | 9.9 | 2 | 2 | 14.8 | 0.5 |
| 9 | 60.5 | 7 | 2 | 2 | 28 | 0.5 |

TABLE 4
Example Composition Components

| Exam- | | | | | | |
|---|---|---|---|---|---|---|
| ple | Mono. | Olig. | CTA | PI | NRPO | Stab. |
| 1 | acryloyl | polyether | thiol | BAPO | poly- | — |
| | morpholine + | urethane | | | sorbate | |
| | mono- | (meth)- | | | | |
| | functional | acrylate | | | | |
| | (meth)- | | | | | |
| | acrylamide | | | | | |
| 2 | acryloyl | polyether | thiol | BAPO | poly- | — |
| | morpholine + | urethane | | | sorbate | |
| | mono- | (meth)- | | | | |
| | functional | acrylate | | | | |
| | (meth)- | | | | | |
| | acrylamide | | | | | |
| 3 | acryloyl | polyether | thiol | BAPO | poly- | — |
| | morpholine + | urethane | | | sorbate | |
| | mono- | (meth)- | | | | |
| | functional | acrylate | | | | |
| | (meth)- | | | | | |
| | acrylamide | | | | | |
| 4 | acryloyl | polyether | thiol | BAPO | poly- | BHT |
| | morpholine + | urethane | | | sorbate | |
| | mono- | (meth)- | | | | |
| | functional | acrylate | | | | |
| | (meth)- | | | | | |
| | acrylamide | | | | | |
| 5 | acryloyl | polyether | thiol | BAPO | poly- | BHT |
| | morpholine + | urethane | | | sorbate | |
| | mono- | (meth)- | | | | |
| | functional | acrylate | | | | |
| | (meth)- | | | | | |
| | acrylamide | | | | | |
| 6 | acryloyl | polyether | thiol | BAPO | poly- | BHT |
| | morpholine + | urethane | | | sorbate | |
| | mono- | (meth)- | | | | |
| | functional | acrylate | | | | |
| | (meth)- | | | | | |
| | acrylamide | | | | | |
| 7 | acryloyl | polyether | thiol | BAPO | poly- | BHT |
| | morpholine + | urethane | | | sorbate | |
| | mono- | (meth)- | | | | |
| | functional | acrylate | | | | |
| | (meth)- | | | | | |
| | acrylamide | | | | | |
| 8 | acryloyl | polyether | thiol | BAPO | poly- | BHT |
| | morpholine + | urethane | | | sorbate | |
| | mono- | (meth)- | | | | |
| | functional | acrylate | | | | |
| | (meth)- | | | | | |
| | acrylamide | | | | | |
| 9 | acryloyl | polyether | thiol | BAPO | poly- | BHT |
| | morpholine | urethane | | | sorbate + | |
| | | (meth)- | | | PEG | |
| | | acrylate | | | | |

TABLE 5
Example Compositions

| Exam- | | | | | | | |
|---|---|---|---|---|---|---|---|
| ple | Mono. | Olig. | CTA | PI | NRPO | Sens. | Stab. |
| 10 | 60-80 | 15-30 | 1-3 | 2-4 | — | — | 0.5-1.5 |
| 11 | 60-75 | 20-30 | 0.5-1.5 | 0.5-1.5 | — | 0.5-1.5 | — |
| 12 | 70-80 | 25-30 | 1-2 | 3-5 | — | — | 0.5-1.5 |
| 13 | 60-70 | 25-35 | 0.5-1.5 | 1-4 | — | 0.5-1.5 | 0.5-1.5 |
| 14 | 65-75 | 20-40 | 0.5-2 | 1-3 | — | — | — |
| 15 | 60-80 | 25-35 | 1-2 | 0.5-5 | — | — | 0.5-1.5 |
| 16 | 60-75 | 15-30 | 1-3 | 0.5-4 | 0.5-5 | 0.5-1.5 | — |
| 17 | 70-80 | 15-25 | 0.5-1.5 | 2-4 | 1-5 | 0.5-1.5 | — |
| 18 | 60-70 | 30-35 | 0.5-1.5 | 0.5-1.5 | — | — | 0.5-1.5 |
| 19 | 65-75 | 25-30 | 0.5-1.5 | 3-5 | — | 0.5-1.5 | 0.5-1.5 |
| 20 | 60-80 | 1-15 | 1-2 | 0.5-5 | 10-30 | — | 0.5-1.5 |
| 21 | 60-75 | 5-15 | 1-2 | 2-4 | 5-25 | 0.5-1.5 | 0.5-1.5 |
| 22 | 65-75 | 5-10 | 1-3 | 2-4 | 15-30 | — | 0.5-1.5 |
| 23 | 60-65 | 5-15 | 1-2 | 2-4 | 15-30 | — | 0.5-1.5 |

With reference to Table 5, the “Mono.” component for Examples 10-23 is hydroxypropylacrylate, N-hydroxyethyl(meth)acrylamide, N,N-dimethyl(meth)acrylamide, N-butyl(meth)acrylamide, N-isopropyl (meth)acrylamide, diacetone(meth)acrylamide, ethoxylated trimethylol propane triacrylate, acryloyl morpholine, hydroxyethyl(meth)acrylate, hydroxypropyl(meth)acrylate, hydroxybutyl(meth)acrylate, or a combination of two or three of the foregoing. The “Olig.” component for Examples 10-23 is monofunctional urethane (meth)acrylate oligomer, aliphatic urethane di(meth)acrylate oligomer, aliphatic polyether urethane (meth)acrylate oligomer; trifunctional aliphatic polyester urethane (meth)acrylate oligomer, or a combination of two or three of the foregoing.

The “CTA” component for Examples 10-23 is pentaerythritol tetra(3-mercaptopropionate) (PETMP), trimethylol-propane tri(3-mercaptopropionate) (TMPMP), glycol di(3-mercaptopropionate) (GDMP), pentaerythritol tetramercaptoacetate (PETMA), trimethylol-propane trimercaptoacetate (TMPMA), glycol dimercaptoacetate (GDMA), ethoxylated trimethylolpropane tri(3-mercaptopropionate) (ETTMP), propyleneglycol 3-mercaptopropionate (PPGMP), tris[2-(3-mercaptopropionyloxy) ethyl] isocyanurate (TEMPIC), polycaprolactone tetra 3-mercaptopropionate, 2,3-di((2-mercaptoethyl) thio)-1-propane-thiol (DMPT), dimercaptodiethylsulfide (DMDS), pentaerythritol tetrakis(3-mercaptobutylate), 1,4-bis(3-mercaptobutylyloxy) butane, 1,3,5-tris (3-mercaptobutyloxethyl)-1,3,5-triazine-2,4,6 (1H,3H,5H)-trione, or a combination of two or three of the foregoing.

The “PI” component for Examples 10-23 is MAPO or BAPO (i.e., MAPO, BAPO, or a MAPO or BAPO salt or species as described above), Sodium TPO-L, Lithium TPO-L, or a combination of two of the foregoing. The “NRPO” component for Examples 10-23 is sorbitan monostearate, sorbitan triesterate, sorbitan monolaurate, ethoxylated sorbitan ester, PEG, poloxamer, or a combination of two or three of the foregoing. The “Sens.” component for Examples 10-23 is ITX or CTX. The “Stab.” component for Examples 10-23 is MEHQ or BHT.

For comparison with some embodiments described herein, Comparative Examples were prepared, using the components and amounts shown in Tables 6 and 7 below. “Comp. Example” in Tables 6 and 7 refers to “Comparative Example”.

TABLE 6
Comparative Compositions

| Comp. | | | | | | |
|---|---|---|---|---|---|---|
| Example | Mono. | Olig. | CTA | PI | NRPO | Stab. |
| 1 | 74.8 | — | — | 0.9 | 23.4 | 0.9 |
| 2 | 53.5 | — | — | 1 | 45.5 | — |

TABLE 7
Comparative Composition Components

| Comp. | | | | | | |
|---|---|---|---|---|---|---|
| Example | Mono. | Olig. | CTA | PI | NRPO | Stab. |
| 1 | acryloyl | — | — | TPO-L | poloxamer | BHT |
| | morpholine | | | | | |
| 2 | acryloyl | — | — | TPO-L | poloxamer | — |
| | morpholine | | | | | |

As indicated above, Comparative Example 1 and Comparative Example 2 each excluded an oligomeric curable material as described herein. Particularly, a hydrolysable, curable oligomer component was excluded. Unlike Examples above (e.g., Examples 1-3 in Tables 3 and 4), Comparative Examples 1 and 2 failed to be usable as eggshell mold materials. Comparative Examples 1 and 2 could be printed with an additive manufacturing system. However, they failed to exhibit desired heat resistance (both began to melt below 150° C.), along with water dispersibility/solubility. In contrast, Examples 1-3 (for instance) were printable into eggshell molds, exhibited heat resistance as described above, and were removable using NaOH solution as described above.

### ADDITIONAL EXAMPLE EMBODIMENTS

Additional non-limiting example Embodiments are provided below.

Embodiment 1. A composition for use in an additive manufacturing system comprising:
a monomeric curable material;
an oligomeric curable material; and
a chain transfer agent,
wherein the monomeric curable material comprises one or more (meth)acrylates and/or one or more (meth)acrylamides; and
wherein the oligomeric curable material comprises one or more hydrolysable oligomeric species.

Embodiment 2. The composition of Embodiment 1 further comprising one or more photoinitiators.

Embodiment 3. The composition of Embodiment 1 or Embodiment 2, further comprising one or more stabilizers.

Embodiment 4. The composition of any of Embodiments 1-3, further comprising one or more non-reactive polymers or oligomers.

Embodiment 5. The composition of any of the preceding Embodiments, wherein the one or more (meth)acrylates and/or one or more (meth)acrylamides are hydrophilic or water soluble.

Embodiment 6. The composition of any of the preceding Embodiments, wherein the monomeric curable material is present in the composition in an amount of 5-80 wt. %, based on the total weight of the composition.

Embodiment 7. The composition of any of the preceding Embodiments, wherein the oligomeric curable material comprises an oligomeric species having two or more polymerizable moieties.

Embodiment 8. The composition of any of the preceding Embodiments, wherein the oligomeric curable material comprises a urethane acrylate oligomer, a urethane methacrylate oligomer, a polyether urethane oligomer, an aliphatic polyester urethane acrylate oligomer, or a combination of two or more of the foregoing.

Embodiment 9. The composition of any of the preceding Embodiments, wherein the oligomeric curable material is present in the composition in an amount of 5-40 wt. %, based on the total weight of the composition.

Embodiment 10. The composition of any of the preceding Embodiments, wherein the chain transfer agent comprises one or more thiols.

Embodiment 11. The composition of any of the preceding Embodiments, wherein the chain transfer agent is present in the composition in an amount of 0.1-10 wt. %, based on the total weight of the composition.

Embodiment 12. The composition of any of the preceding Embodiments, wherein the composition, when cured, exhibits a tensile strength of greater than 40 MPa when determined according to ASTM D638.

Embodiment 13. The composition of any of the preceding Embodiments, wherein the composition, when cured, exhibits a glass transition temperature (T_{g}) of at least 105° C., at least 110° C., or at least 115° C., when measured using DMA as the maximum of tan delta.

Embodiment 14. The composition of any of the preceding Embodiments, wherein the composition, in an uncured state, has a dynamic viscosity of 5 cP to 30 cP at a temperature of 80° C., when determined according to ASTM D2983.

Embodiment 15. A method of forming a three-dimensional article by additive manufacturing, the method comprising:
providing the composition of any of Embodiments 1-14; and
selectively curing a portion of the composition.

Embodiment 16. The method of Embodiment 15, wherein providing the composition comprises selectively depositing layers of the composition in a fluid state onto a substrate.

Embodiment 17. The method of Embodiment 16 further comprising supporting at least one of the layers of the composition with a support material.

Embodiment 18. The method of Embodiment 17 further comprising removing the support material from the article.

Embodiment 19. The method of Embodiment 18, wherein removing the support material comprises melting the support material.

Embodiment 20. The method of any of Embodiments 15-19, wherein curing comprises photocuring.

Embodiment 21. The method of any of Embodiments 15-20, wherein the article is an eggshell mold.

Embodiment 22. The method of Embodiment 21, wherein the eggshell mold has an average wall thickness of less than 10 mm.

Embodiment 23. A method of forming a three-dimensional article by molding, the method comprising:
providing a mold defining an interior volume;
injecting a fluid material into the interior volume of the mold;
solidifying the fluid material within the interior volume of the mold to form the article; and removing the mold from the formed article,
wherein the mold comprises or is formed from the composition of any of Embodiments 1-14.

Embodiment 24. The method of Embodiment 23, wherein providing the mold comprises forming the mold using additive manufacturing.

Embodiment 25. The method of Embodiment 23 or Embodiment 24, wherein the fluid material is injected at a temperature of at least 100° C., 150° C., at least 200° C., or at least 220° C.

Embodiment 26. The method of any of Embodiments 23-25, wherein the fluid material comprises a polymeric material.

Embodiment 27. The method of any of Embodiments 23-25, wherein the fluid material comprises a metallic material.

Embodiment 28. The method of any of Embodiments 23-27, wherein solidifying the fluid material comprises cooling the fluid material below a melting point of the fluid material.

Embodiment 29. The method of any of Embodiments 23-28, wherein removing the mold from the article comprises dissolving or dispersing the mold in water or an aqueous solution.

Embodiment 30. The method of Embodiment 29, wherein the water or aqueous solution has a pH of 7 to 14.

Embodiment 31. A printed three-dimensional article formed from the composition of any of Embodiments 1-14.

Embodiment 32. The article of Embodiment 31, wherein the article is a mold.

Embodiment 33. An article formed by the method of any of Embodiments 15-22.

Embodiment 34. An article formed by the method of any of Embodiments 23-30.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composition for use in an additive manufacturing system comprising:
a monomeric curable material;
an oligomeric curable material; and
a chain transfer agent,
wherein the monomeric curable material comprises one or more (meth)acrylates and/or one or more (meth)acrylamides; and
wherein the oligomeric curable material comprises one or more hydrolysable oligomeric species.

2. The composition of claim 1 further comprising one or more photoinitiators.

3. The composition of claim 1 further comprising one or more stabilizers.

4. The composition of claim 1 further comprising one or more non-reactive polymers or oligomers.

5. The composition of claim 1, wherein the one or more (meth)acrylates and/or one or more (meth)acrylamides are hydrophilic or water soluble.

6. The composition of claim 1, wherein the monomeric curable material is present in the composition in an amount of 5-80 wt. %, based on the total weight of the composition.

7. The composition of claim 1, wherein the oligomeric curable material comprises an oligomeric species having two or more polymerizable moieties.

8. The composition of claim 1, wherein the oligomeric curable material comprises a urethane acrylate oligomer, a urethane methacrylate oligomer, a polyether urethane oligomer, an aliphatic polyester urethane acrylate oligomer, or a combination of two or more of the foregoing.

9. The composition of claim 1, wherein the oligomeric curable material is present in the composition in an amount of 5-40 wt. %, based on the total weight of the composition.

10. The composition of claim 1, wherein the chain transfer agent comprises one or more thiols.

11. The composition of claim 1, wherein the chain transfer agent is present in the composition in an amount of 0.1-10 wt. %, based on the total weight of the composition.

12. The composition of claim 1, wherein the composition, when cured, exhibits a tensile strength of greater than 40 MPa when determined according to ASTM D638.

13. The composition of claim 1, wherein the composition, when cured, exhibits a glass transition temperature (T_{g}) of at least 105° C., when measured using DMA as the maximum of tan delta.

14. The composition of claim 1, wherein the composition, in an uncured state, has a dynamic viscosity of 5 cP to 30 cP at a temperature of 80° C., when determined according to ASTM D2983.

15. A method of forming a three-dimensional article by additive manufacturing, the method comprising:
providing the composition of claim 1; and
selectively curing a portion of the composition.

16. The method of claim 15, wherein providing the composition comprises selectively depositing layers of the composition in a fluid state onto a substrate.

17. The method of claim 16 further comprising supporting at least one of the layers of the composition with a support material.

18. The method of claim 17 further comprising removing the support material from the article.

19. A method of forming a three-dimensional article by molding, the method comprising:
providing a mold defining an interior volume;
injecting a fluid material into the interior volume of the mold;
solidifying the fluid material within the interior volume of the mold to form the article; and
removing the mold from the formed article,
wherein the mold is formed from the composition of claim 1.

20. The method of claim 19, wherein:
providing the mold comprises forming the mold using additive manufacturing;
solidifying the fluid material comprises cooling the fluid material below a melting point of the fluid material;
removing the mold from the article comprises dissolving or dispersing the mold in water or an aqueous solution; and
the mold comprises an eggshell mold having an average wall thickness of less than 10 mm.
